(19) United States
(12) Patent Application Publication
(10) Pub. No.: US 2014/0337898 A1
(43) Pub. Date: Nov. 13, 2014

(54) DVB-S RECEIVER DEVICE, ADAPTER FOR INTERCONNECTING A TUNER AND A SCART CONNECTOR OF THE DVB-S RECEIVER DEVICE, AND METHOD FOR AUTOMATICALLY DETECTING AN OUTPUT VOLTAGE OF THE TUNER

(71) Applicant: WISTRON CORPORATION, New Taipei City (TW)

(72) Inventors: Yuen-Lang Chen, New Taipei City (TW); Chun-Te Hung, New Taipei City (TW)

(73) Assignee: WISTRON CORPORATION, New Taipei City (TW)

(21) Appl. No.: 14/143,333

(22) Filed: Dec. 30, 2013

(30) Foreign Application Priority Data
May 7, 2013 (TW) 102116209

(51) Int. Cl. H04N 21/61; H04H 40/90

(52) U.S. Cl. CPC H04N 21/6112; H04H 40/90
USPC 725/70

(57) ABSTRACT

A Digital Video Broadcasting-Satellite (DVB-S) receiver device includes a tuner, a SCART (Syndicat des Constructeurs d'Appareils Radiorécepteurs et Téléviseurs) connector and a system on chip (SOC). The tuner is for generating an output voltage. The SCART connector is for receiving the output voltage. The SOC is configured to receive a voltage signal associated with the output voltage outputted by the SCART connector, to digitize the voltage signal into a digital value, and to determine whether the digital value conforms with a default value so as to output a determination result.

### CROSS-REFERENCE TO RELATED APPLICATION

This application claims priority of Taiwanese Application No. 102116209, filed on May 7, 2013.

### BACKGROUND OF THE INVENTION

1. Field of the Invention

The present invention relates to a Digital Video Broadcasting-Satellite (DVB-S) receiver device, more particularly to a DVB-S receiver device capable of automatic detection of an output voltage of a tuner thereof.

2. Description of the Related Art

Referring to FIG. 1, a conventional Digital Video Broadcasting-Satellite (DVB-S) television 1 is shown to include a tuner 10 that is connected electrically to a satellite dish antenna 4. The conventional DVB-S television 1 receives a DVB-S signal via the satellite dish antenna 4, and allows users to select desired channels by virtue of the tuner 10. The tuner 10 has to supply output voltages of 13V and 18V to a Low Noise Amplifier (LNA) 40 of the satellite dish antenna 4 via a coaxial wire 100 that is connected electrically between the tuner 10 and the LNA 40 for transmitting the DVB-S signal. In order to ensure that the tuner 10 normally outputs the output voltages of 13V and 18V, a conventional method is to manually detect, at a coaxial connector 11 of the tuner 10, whether the output voltages outputted by the tuner 10 are 13V and 18V, before the conventional DVB-S television 1 leaves the factory. However, the conventional method requires additional time, cost and manpower.

### SUMMARY OF THE INVENTION

Therefore, an object of the present invention is to provide a Digital Video Broadcasting-Satellite (DVB-S) receiver device that may automatically detect an output voltage of a tuner of the DVB-S receiver device.

Accordingly, a DVB-S receiver device comprises a tuner, a SCART (Syndicat des Constructeurs d'Appareils Radiorécepteurs et Téléviseurs) connector, and a system on chip (SOC). The tuner is for generating an output voltage. The SCART connector is for receiving the output voltage. The SOC is configured to receive a voltage signal associated with the output voltage outputted by the SCART connector, to digitize the voltage signal into a digital value, and to determine whether the digital value conforms with a default value so as to output a determination result.

Another object of the present invention is to provide an adapter for electrically interconnecting a coaxial connector of a tuner and a SCART connector, which are provided within a Digital Video Broadcasting-Satellite (DVB-S) receiver device, for transmitting an output voltage from the tuner to the SCART connector.

According to another aspect, an adapter comprises a coaxial cable, a coaxial connecting terminal, and a SCART connecting terminal. The coaxial connecting terminal is provided at one end of the coaxial cable, and is adapted to be electrically connected to the coaxial connector of the tuner for receiving the output voltage from the tuner. The SCART connecting terminal is provided at the other end of the coaxial cable, and is adapted to be electrically connected to the SCART connector for transmitting the output voltage from the tuner to the SCART connector.

Yet another object of the present invention is to provide a method for automatically detecting an output voltage of a tuner of a Digital Video Broadcasting-Satellite (DVB-S) receiver device. The DVB-S receiver device further includes a SCART connector and a system on chip (SOC).

According to yet another aspect, the method comprises the following steps of: outputting, by the tuner, the output voltage to the SCART connector through an adapter electrically connected therebetween; outputting, by the SCART connector, the output voltage to the SOC; receiving, by the SOC, a voltage signal associated with the output voltage outputted by the SCART connector; digitizing, by the SOC, the voltage signal received in the previous step into a digital value; determining, by the SOC, whether the digital value conforms with a default value; and outputting, by the SOC, a determination result made in previous step.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram for illustrating a connection relationship between a tuner of a conventional Digital Video Broadcasting-Satellite (DVB-S) television and a satellite dish antenna;

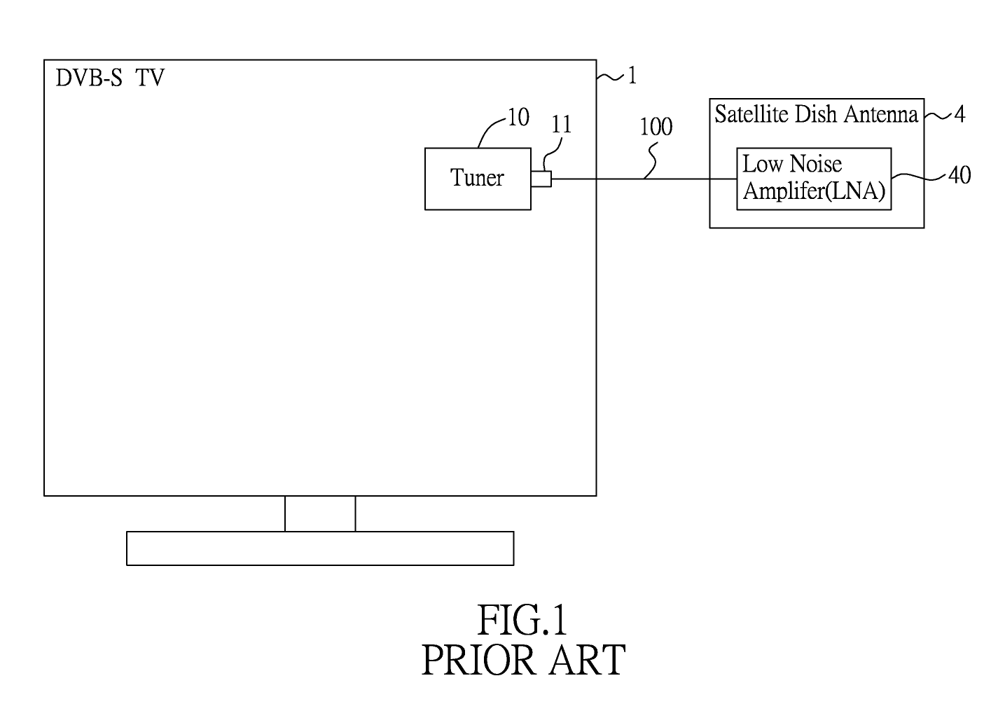

FIG. 2 is a block diagram of a DVB-S television used with a DVB-S receiver device according to an embodiment of the present invention;

FIG. 3 is a block diagram illustrating connection between a tuner and a SCART connector of the DVB-S receiver device via an adapter according to an embodiment for detecting output voltages of the tuner;

FIG. 4 is a perspective view of the adapter for interconnecting the tuner and the SCART connector;

FIG. 5 is a circuit diagram for illustrating a connection relationship among the SCART connector, a voltage divider and a system on chip of the DVB-S receiver device; and

FIG. 6 is a flowchart for illustrating consecutive steps of a method for automatically detecting the output voltages of the tuner of the DVB-S receiver device according to an embodiment of the present invention.

### DETAILED DESCRIPTION OF THE EMBODIMENT

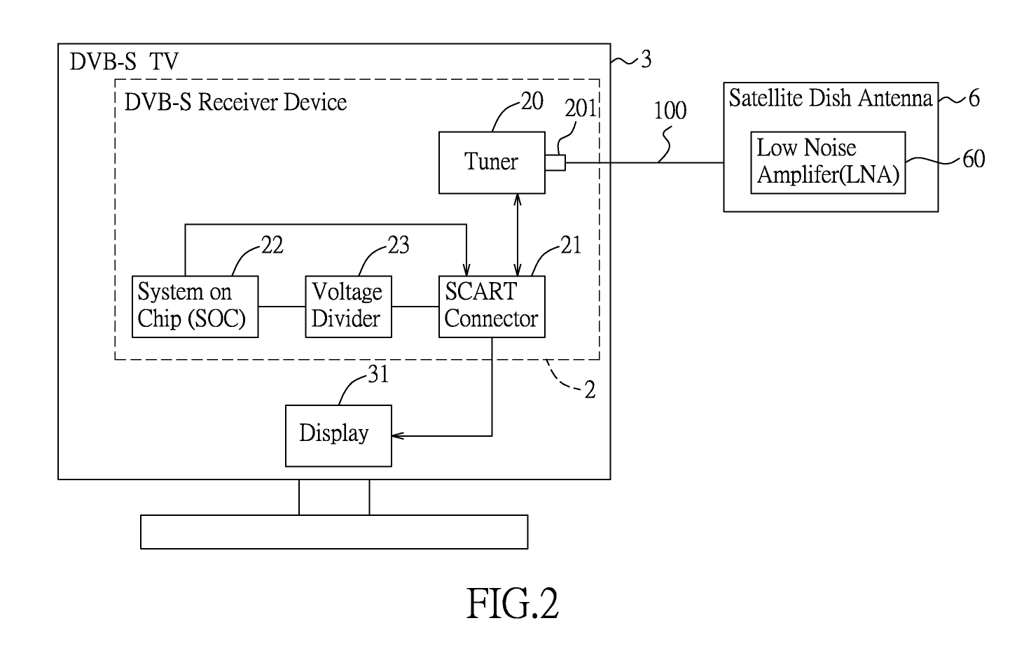

Referring to FIG. 2, a Digital Video Broadcasting-Satellite (DVB-S) receiver device 2 according to an embodiment of this invention is shown to be a built-in component of a DVB-S television 3 to enable the DVB-S television 3 to receive a DVB-S signal. In other embodiments, the DVB-S receiver device 2 may be an external component electrically connected to a television to configure the television to become a DVB-S television capable of receiving a DVB-S signal. The DVB-S receiver device 2 includes a tuner 20, a SCART (Syndicat des Constructeurs d'Appareils Radiorécepteurs et Téléviseurs) connector 21 connected electrically between the tuner 21 and a display 31 of the DVB-S television 3, and a system on chip (SOC) 22 electrically connected to the SCART connector 21.

The tuner 20 is connected electrically to a satellite dish antenna 6 via a coaxial wire 100, which is generally used for transmitting a radio frequency signal (i.e., the DVB-S signal), for receiving the DVB-S signal from the satellite dish antenna 6. The tuner 20 is operable to demodulate the DVB-S signal into a television signal according to a control signal received from the SOC 22 through the SCART connector 21, and to output the television signal via the SCART connector 21 to the display 31 of the DVB-S television 3 for display.

In addition to the demodulation of the DVB-S signal received from the satellite dish antenna 6, the tuner 20 is further able to supply output voltages of 13V and 18V at a coaxial connector 201 thereof, which is electrically connected to the coaxial wire 100 for receiving the DVB-S signal, to a Low Noise Amplifier (LNA) 40 of the satellite dish antenna 6 via the coaxial wire 100. According to the embodiment, there is provided a method for automatically detecting whether the output voltages outputted by the coaxial connector 201 of the tuner 20 are 13V and 18V by using of the SOC 22 to analyze a voltage signal associated with the output voltages transmitted through the SCART connector 21.

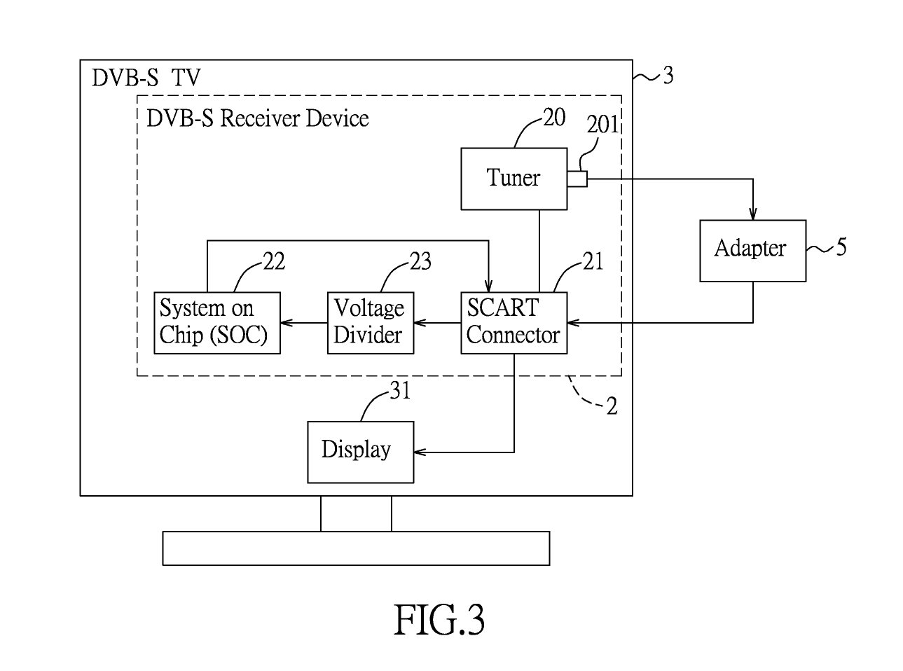

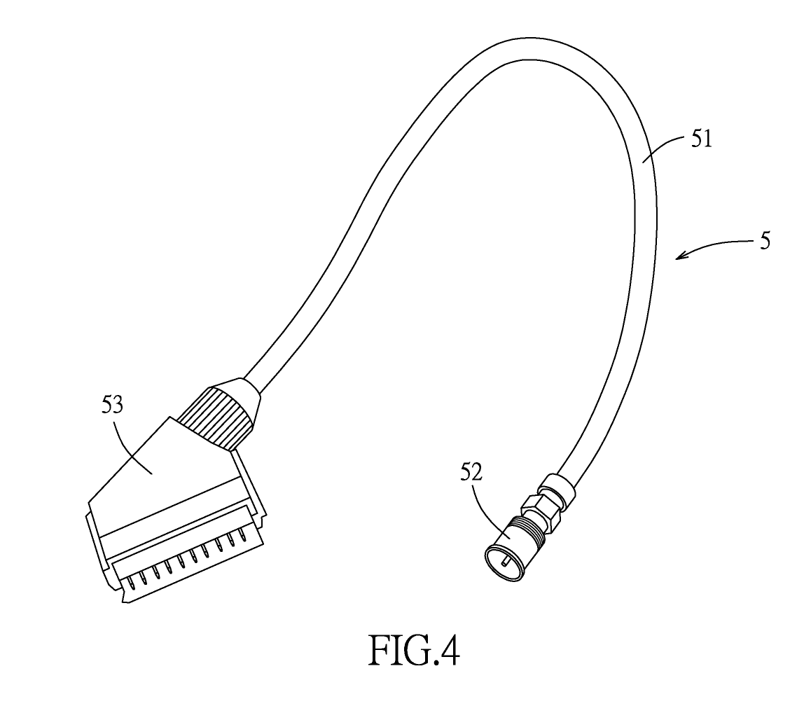

It is noted that, since it is not possible to directly connect the coaxial connector 201 of the tuner 20 to the SCART connector 21 due to structural differences therebetween, as shown in FIG. 3, an adapter 5 is required to electrically interconnect the coaxial connector 201 and the SCART connector 21 for transmitting the output voltages from the coaxial connector 201 to the SCART connector 21 before detection of the output voltages. Referring further to FIG. 4, the adapter 5 includes a coaxial cable 51, a coaxial connecting terminal 52, and a SCART connecting terminal 53. The coaxial connecting terminal 52 is provided at one end of the coaxial cable 51, and is adapted to be electrically connected to the coaxial connector 201 of the tuner 20 for receiving the output voltages from the tuner 20. The SCART connecting terminal 53 is provided at the other end of the coaxial cable 51, and is adapted to be electrically connected to the SCART connector 21 for transmitting the output voltages from the tuner 20 to the SCART connector 21.

Moreover, since the SOC 22 can only receive a voltage equal to or less than 3.3V, in this embodiment, the DVB-S receiver device 2 further includes a voltage divider 23 electrically connected between the SCART connector 21 and the SOC 22, as shown in FIGS. 2 and 3. The voltage divider 23 is for receiving the output voltage from the SCART connector 21, for dividing/bucking the output voltage into a divided voltage less than 3.3V, and for outputting the divided voltage to the SOC 22 as the voltage signal.

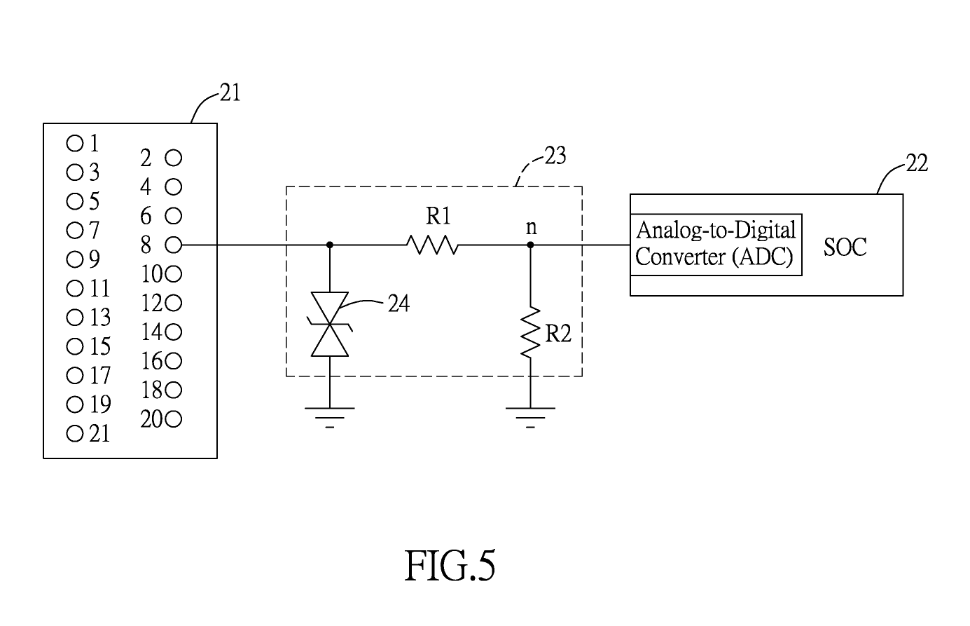

Referring to FIG. 5, the SCART connector 21 outputs the output voltages received from the tuner 20 at an eighth pin of the SCART connector 21. The voltage divider 23 includes a voltage-limiting component 24, a first resistor (R1) and a second resistor (R2). The voltage-limiting component 24 has one end that is electrically connected to the eighth pin of the SCART connector 21, and the other end that is grounded. The first resistor (R1) is electrically connected between the SCART connector 21 and an analog-to-digital converter (ADC) pin of the SOC 22. The second resistor (R2) has one end that is electrically connected to the ADC pin of the SOC 22, and the other end that is grounded.

The voltage-limiting component 24 is configured to limit the divided voltage at a common node (n) between the first and second resistors (R1, R2) to be not greater than 3.3V. Specifically, the voltage-limiting component 24 may shunt excess current when the output voltages from the eighth pin of the SCART connector 21 exceed 3.3V. In practice, the divided voltages at the common node (n) between the first and second resistors (R1, R2) are less than 3V for the sake of safety. For instance, a ratio of a resistance value of the first resistor (R1) to that of the second resistor (R2) is preferably 21:4. Accordingly, the divided voltage at the common node (n) between the first and second resistors (R1, R2) will be substantially 2.08V when the output voltage from the tuner 20 is 13V, and will be substantially 2.88V when the output voltage from the tuner 20 is 18V. The values of 2.08V and 2.88V will be recorded in the SOC 22 in advance as default values.

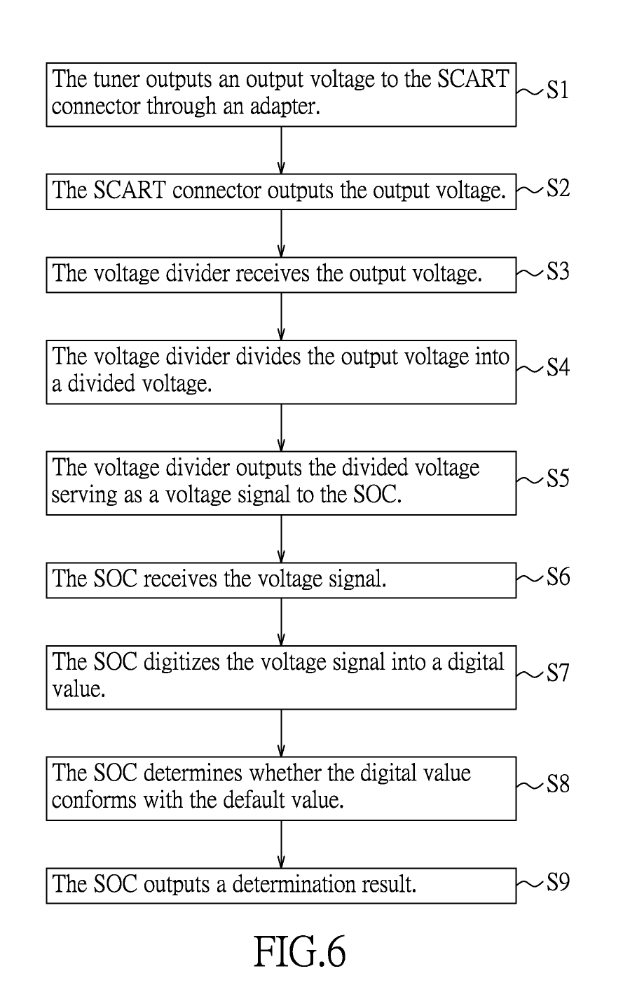

Referring to FIG. 6, when the tuner 20 supplies an output voltage to the SCART connector 21 through the adapter 5 in step S1, the SCART connector 21 outputs, at the eighth pin, the output voltage thus received to the voltage divider 23 in step S2. Then, the voltage divider 23 receives the output voltage from the SCART connector 21 in step S3, divides the output voltage into the divided voltage in step S4, and outputs the divided voltage to the ADC pin of the SOC 22 as the voltage signal in step S5. Upon receiving the voltage signal from the voltage divider 23 in step S6, the SOC 22 digitizes the voltage signal into a digital value in step S7, and determines whether the digital value conforms with the default value (i.e., 2.08 or 2.88 in this embodiment) in step S8. If the digital value is 2.08, this indicates that the tuner 20 normally outputs the output voltage of 13V. If the digital value is 2.88, this indicates that the tuner 20 normally outputs the output voltage of 18V. In these two cases, the SOC 22 outputs, via the SCART connector 21, a determination result to the display 31, enabling the display 31 to show a message “pass” thereon. In cases where the digital value is neither 2.08 nor 2.88, it is determined that the tuner 20 abnormally outputs the output voltage, and the SOC 22 outputs, via the SCART connector 21, a determination result to the display 31, enabling the display 31 to show a message “fail” thereon.

To conclude, in the embodiment of the present invention, the output voltage of the tuner 20 may be transmitted to the SCART connector 21 via the adapter 5, and then, the voltage divider 23 divides the output voltage from the SCART connector 21 into the divided voltage which is suitable for use by the SOC 22. Consequently, the SOC 22 may digitize the voltage signal (i.e., the divided voltage) into the digital value and automatically determine whether the digital value conforms with the default value. By virtue of the DVB-S receiver device 2 of the present invention, manual detection of the output voltage may be eliminated, thereby saving time, cost and manpower.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A Digital Video Broadcasting-Satellite (DVB-S) receiver device comprising:
a tuner for generating an output voltage;
a SCART (Syndicat des Constructeurs d'Appareils Radiorécepteurs et Téléviseurs) connector for receiving the output voltage; and
a system on chip (SOC) configured to receive a voltage signal associated with the output voltage outputted by said SCART connector, to digitize the voltage signal into a digital value, and to determine whether the digital value conforms with a default value so as to output a determination result.

2. The DVB-S receiver device as claimed in claim 1, wherein said tuner is configured to be electrically connected to said SCART connector through an adapter for transmitting the output voltage.

3. The DVB-S receiver device as claimed in claim 1, further comprising a voltage divider that is electrically connected between said SCART connector and said SOC for receiving the output voltage from said SCART connector and for dividing the output voltage into a divided voltage serving as the voltage signal.

4. The DVB-S receiver device as claimed in claim 1, wherein said SCART connector is electrically connected to said SOC and is adapted to be further electrically connected to a display,
wherein said SOC is configured to output the determination result via said SCART connector to the display for displaying the determination result on the display.

5. An adapter for electrically interconnecting a coaxial connector of a tuner and a SCART (Syndicat des Constructeurs d'Appareils Radiorécepteurs et Téléviseurs) connector, which are provided within a Digital Video Broadcasting-Satellite (DVB-S) receiver device, for transmitting an output voltage from the tuner to the SCART connector, said adapter comprising:
a coaxial cable;
a coaxial connecting terminal that is provided at one end of said coaxial cable, and that is adapted to be electrically connected to the coaxial connector of the tuner for receiving the output voltage from the tuner; and
a SCART connecting terminal that is provided at the other end of said coaxial cable, and that is adapted to be electrically connected to the SCART connector for transmitting the output voltage from the tuner to the SCART connector.

6. A method for automatically detecting an output voltage of a tuner of a Digital Video Broadcasting-Satellite (DVB-S) receiver device, the DVB-S receiver device further including a SCART connector and a system on chip (SOC), said method comprising the following steps of:
(A) outputting, by the tuner, the output voltage to the SCART connector through an adapter electrically connected therebetween;
(B) outputting, by the SCART connector, the output voltage to the SOC;
(C) receiving, by the SOC, a voltage signal associated with the output voltage outputted by the SCART connector;
(D) digitizing, by the SOC, the voltage signal received in step (C) into a digital value;
(E) determining, by the SOC, whether the digital value conforms with a default value; and
(F) outputting, by the SOC, a determination result made in step (E).

7. The method as claimed in claim 6, the DVB-S receiver device further including a voltage divider electrically connected between the SCART connector and the SOC, wherein said method further comprises, between steps (B) and (C), the following steps of:
receiving, by the voltage divider, the output voltage from the SCART connector;
dividing, by the voltage divider, the output voltage into a divided voltage; and
outputting, by the voltage divider, the divided voltage serving as the voltage signal to the SOC.

8. The method as claimed in claim 6, the SCART connector being electrically connected between the SOC and a display,
wherein, in step (F), the SOC outputs the determination result via the SCART connector to the display for displaying the determination result on the display.
